(19) United States
(12) Patent Application Publication
(10) Pub. No.: US 2012/0168566 A1
(43) Pub. Date: Jul. 5, 2012

(54) System for global earth navigation using inclined geosynchronous orbit satellite

(75) Inventors: Byoung Sun LEE, Daejeon (KR); Yoo La HWANG, Daejeon (KR); Jae Hoon KIM, Daejeon (KR)

(73) Assignee: Electronics and Telecommunications Research Institute, Daejeon (KR)

(21) Appl. No.: 13/333,333

(22) Filed: Aug. 7, 2011

(30) Foreign Application Priority Data
Dec. 22, 2010 (KR) 10-2010-0132901

(51) Int. Cl. B64G 1/10

(52) U.S. Cl. 244/158.4

(57) ABSTRACT

A global earth navigation satellite system may be provided. The global earth navigation satellite system may include a group of satellites including at least one inclined geosynchronous satellite disposed in at least one orbital plane distinguished based on an interval determined based on a longitudinal coordinate of the earth, and the at least one inclined geosynchronous satellite may be disposed in the at least one orbital plane at predetermined intervals, and may revolve around the earth at a predetermined inclination of satellite orbit so as to provide, over time, geometric shape change information associated with the earth, geometric shape change information associated with a low earth orbit satellite, and geometric shape change information associated with a geostationary satellite.

### CROSS-REFERENCE TO RELATED APPLICATION

This application claims the benefit of Korean Patent Application No. 10-2010-0132901, filed on Dec. 22, 2010, in the Korean Intellectual Property Office, the disclosure of which is incorporated herein by reference.

### BACKGROUND

1. Field

The present invention relates to a global earth navigation satellite system and method using a group of inclined geosynchronous satellites.

2. Description of the Related Art

A global earth navigation system of the U.S.A, that is, the global positioning system (GPS), has been utilized in Korea to accurately measure times and three-dimensional (3D) locations of vehicles, airplanes, and vessels equipped with a GPS receiver, and low earth orbit satellites.

In general, the global earth navigation system receives, using a user's GPS receiver, microwaves sent from at least 24 artificial satellites orbiting along a middle earth orbit, and determines a time and a position vector of the GPS receiver.

For example, a GPS satellite group is composed of at least 24 satellites, and six orbital planes having an inclination of about 55 degrees and including four satellites each.

Similar to the GPS, Russia operates a global navigation satellite system, named GLONASS, and the European Union (EU) has completed design of and is currently building a satellite, named Galileo, to establish a global navigation satellite system.

Also, in Japan, an inclined geosynchronous satellite, named quasi-zenith satellite system (QZSS), has been launched into orbit to advance the GPS system, since a view of the GPS satellite is obscured due to buildings in a downtown area, in the middle latitudes.

To determine a location and a time of an area where the GPS receiver is located using the global navigation satellite system, for example, GPS, GLONAS, Galileo, and the like, signals need to be received from at least four satellites.

Accordingly, for vehicles, vessels, and airplanes existing on or near a surface of the earth, no difficulty exists in determining a time and a 3D location by receiving a signal from the global navigation satellite system.

In the past, a distance was measured by a ground station, and an orbit of an artificial satellite was determined based on varied measured data, to control and manage the artificial satellite orbiting along a low earth orbit. Currently, the low earth orbit satellite determines an accurate orbit using a satellite navigation signal received directly using a global earth navigation satellite system, without using the distance data measured by the ground station.

A geostationary satellite having a rotation cycle of 23 hours 56 minutes and 4 seconds and an inclination of satellite orbit of zero degrees, has been utilized widely for communication, broadcasting, weather observation, and oceanographic observation.

A location of the geostationary satellite may need to be determined with a high accuracy, to perform an image process of weather observation data and oceanographic observation data, precisely.

The geostationary satellite is orbiting at an altitude of 35,786 kilometers (km) that is higher than an altitude of approximately 20,000 km of the currently utilized global navigation satellite system, for example, GPS, GLONASS, and Galileo and thus, it is difficult to receive a signal from the global navigation satellite system and to determine a time and a 3D location.

Accordingly, to control and manage the geostationary satellite, the ground station may transmit a distance measurement signal and the geostationary satellite may send the distance measurement signal back to the ground station and thus, a distance may be measured. Also, the ground station may measure an elevation angle an azimuth angle towards the geostationary satellite, and may determine an orbit of the geostationary satellite based on the measured data.

However, the orbit of the geostationary satellite is less accurate than the low earth orbit satellite that determines a location through the global earth navigation satellite system.

To operate the global navigation satellite system using a middle earth orbit, for example, GPS, GLONASS, and Galileo, at least 24 satellites are used, and numerous material resources and human resources are required. Also, the global navigation satellite system may not be applicable to the satellite navigation of the geostationary satellite orbiting at a higher altitude than the middle earth orbit.

### SUMMARY

According to an aspect of the present invention, there is provided a global earth navigation satellite system, the system including a group of satellites including at least one inclined geosynchronous satellite disposed in at least one orbital plane distinguished based on an interval determined based on a longitudinal coordinate of the earth, and the at least one inclined geosynchronous satellite is disposed in the at least one orbital plane at predetermined intervals, and revolves around the earth at a predetermined inclination of satellite orbit so as to provide, over time, geometric shape change information associated with the earth, geometric shape change information associated with a low earth orbit satellite, and geometric shape change information associated with a geostationary satellite.

A target satellite of which a location is to be determined may be one of the low earth orbit satellite and the geostationary satellite.

The at least one inclined geosynchronous satellite may revolve around the earth at the same altitude as the geostationary satellite.

The at least one orbital plane may be situated at intervals of 60 degrees based on the longitudinal coordinate of the earth, and may be distinguished as six orbital planes.

The group of the satellites may include 12 inclined geosynchronous satellites, two inclined geosynchronous satellites being disposed in each of the six orbital planes.

The at least one inclined geosynchronous satellite may revolve around the earth at an inclination of satellite orbit of 45 degrees so as to provide, over time, geometric shape change information associated with the earth, geometric shape change information associated with the low earth orbit satellite, and geometric shape change information associated with the geostationary satellite.

The at least one inclined geosynchronous satellite may include two inclined geosynchronous satellites included in the same orbital plane, spaced 180 degrees apart from each other, and two inclined geosynchronous satellites included in different orbital planes of the orbit, spaced 60 degrees apart from each other.

According to an aspect of the present invention, there is provided an inclined geosynchronous satellite, including a navigation electronic unit to generate a navigation signal, a satellite bus unit to generate telemetry data and a telecommand signal to control the inclined geosynchronous satellite, and at least one inclined geosynchronous satellite is disposed in at least one orbital plane distinguished based on an interval determined based on a longitudinal coordinate of the earth, and the at least one inclined geosynchronous satellite is disposed in the at least one orbital plane at predetermined intervals, and revolves around the earth at a predetermined inclination of satellite orbit so as to provide, over time, geometric shape change information associated the earth, geometric shape change information associated a low earth orbit satellite, and geometric shape change information associated a geostationary satellite.

The navigation electronic unit may include an atomic clock unit to generate a reference time, a navigation computer unit to generate the navigation signal, and a navigation signal transceiver to transmit and receive the navigation signal by converting the navigation signal to a signal recognizable by a different satellite or a satellite signal collecting apparatus established on the earth.

The satellite bus unit may include a telecommand data processor to generate telemetry data by measuring a state of the inclined geosynchronous satellite, and to receive the telecommand signal to convert the received telecommand signal to command data.

The satellite bus unit may include a command signal transceiver to receive the telecommand signal and to transmit the telecommand signal.

According to an aspect of the present invention, there is provided a global earth navigation method, the method including receiving geometric shape change information associated with a target satellite over time through at least one inclined geosynchronous satellite, and determining a location of the target satellite based on the received geometric shape change information, and a group of satellites includes the at least one inclined geosynchronous satellite disposed in at least one orbital plane distinguished based on an interval determined based on a longitudinal coordinate of the earth, and the at least one inclined geosynchronous satellite is disposed in the at least one orbital plane at predetermined intervals, and revolves around the earth so as to provide, over time, geometric shape change information associated with the earth and geometric shape change information associated with the target satellite.

Additional aspects, features, and/or advantages of the invention will be set forth in part in the description which follows and, in part, will be apparent from the description, or may be learned by practice of the invention.

### DETAILED DESCRIPTION

These and/or other aspects, features, and advantages of the invention will become apparent and more readily appreciated from the following description of embodiments, taken in conjunction with the accompanying drawings of which:

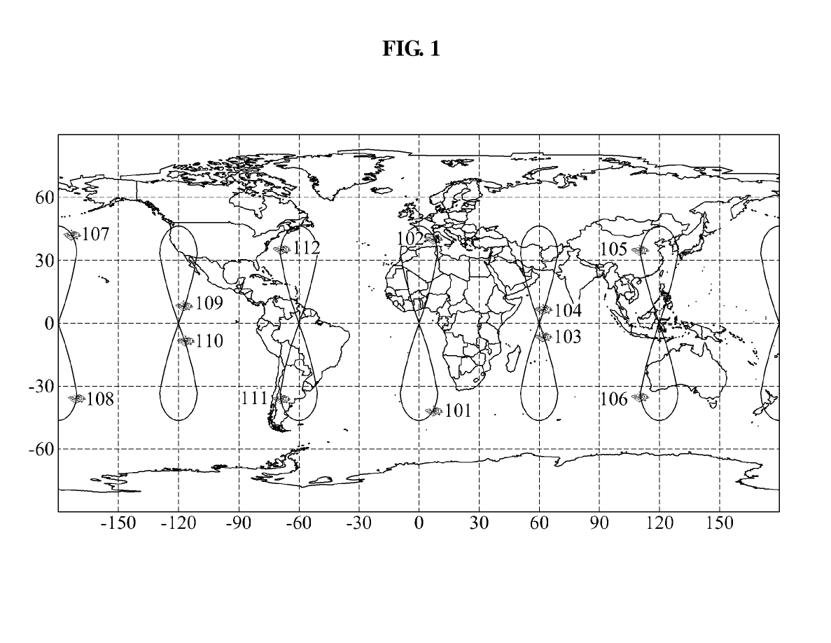

FIG. 1 illustrates a group of satellites in a global earth navigation satellite system, two-dimensionally, according to an embodiment of the present invention;

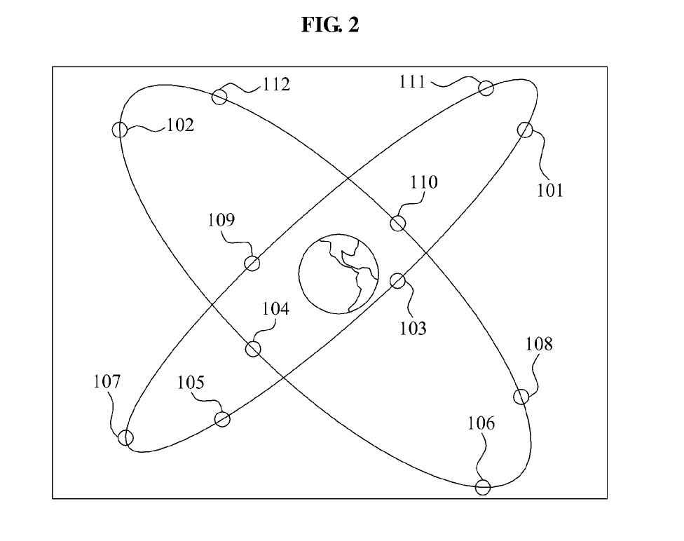

FIG. 2 illustrates a group of satellites in a global earth navigation satellite system, three-dimensionally, according to an embodiment of the present invention;

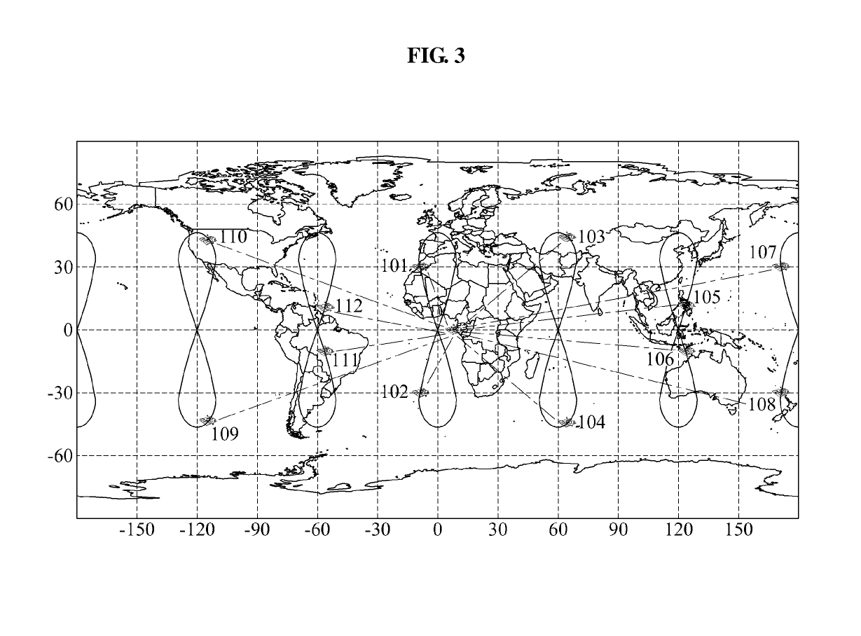

FIG. 3 illustrates a ground track of each satellite based on determination of a location of a geostationary satellite in a global earth navigation satellite system according to an embodiment of the present invention;

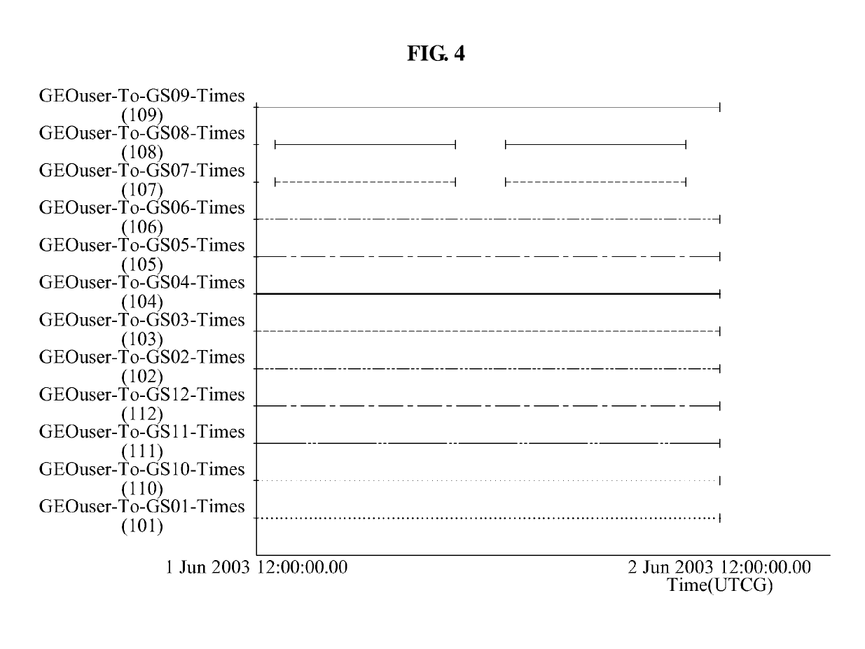

FIG. 4 illustrates a number of inclined geosynchronous satellites shown from a geostationary orbit, to determine a location of a geostationary satellite using a global earth navigation satellite system according to an embodiment of the present invention;

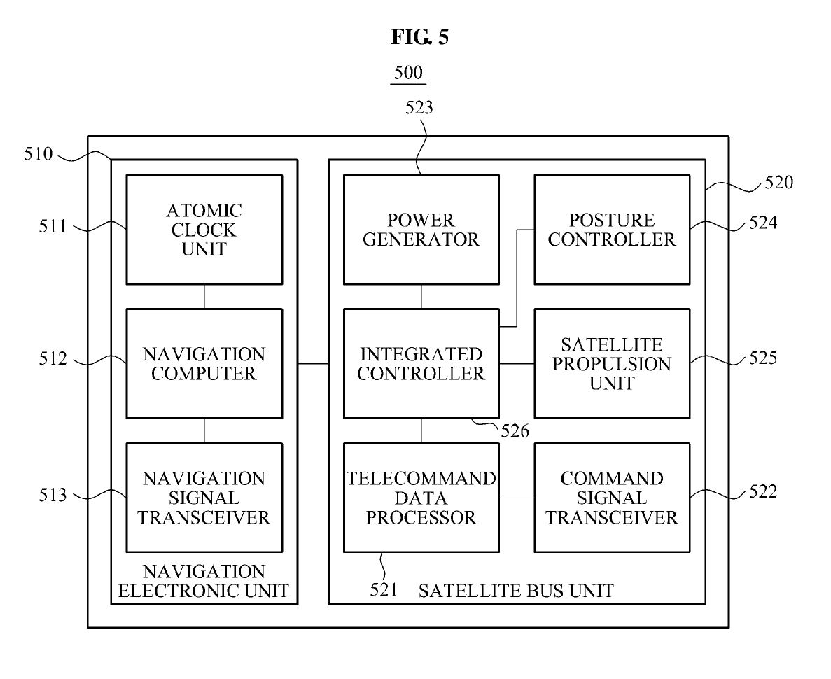

FIG. 5 is a block diagram illustrating a configuration of an inclined geosynchronous satellite in a global earth navigation satellite system according to an embodiment of the present invention;

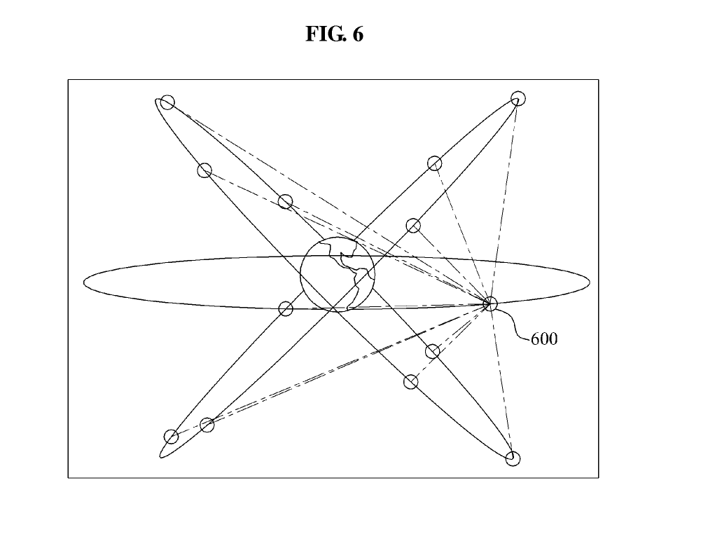

FIG. 6 illustrates an example that determines a location of a geostationary satellite in a three-dimensional (3D) space using a global earth navigation satellite system according to an embodiment of the present invention;

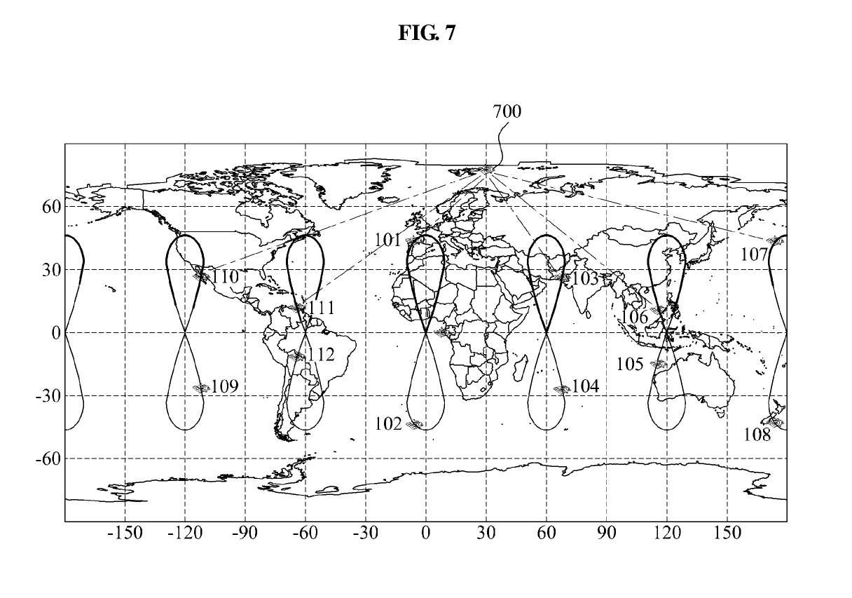

FIG. 7 illustrates a ground track of an inclined geosynchronous satellite deployed to determine a location of a satellite located at a surface of the earth, using a global earth navigation satellite system according to an embodiment of the present invention;

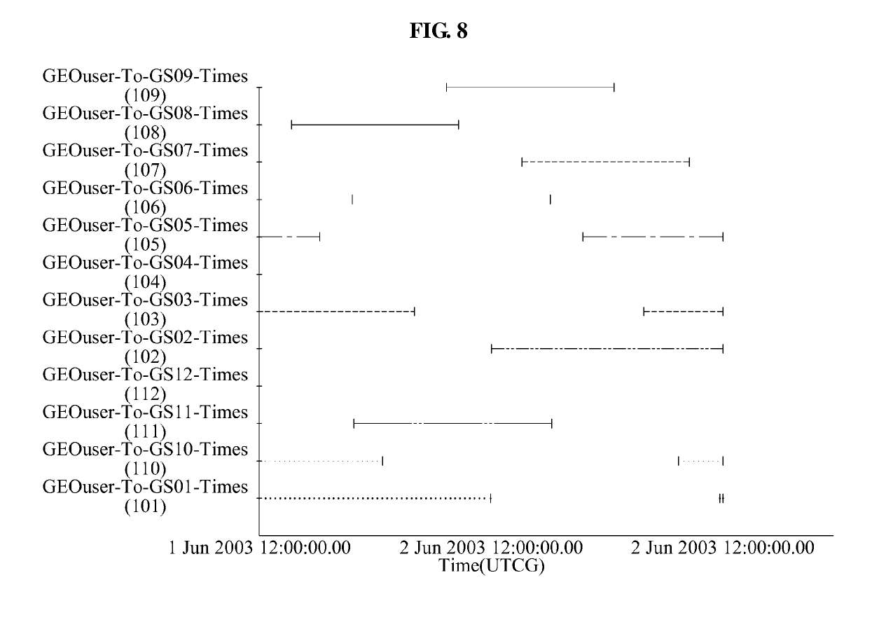

FIG. 8 illustrates a number of inclined geosynchronous satellites shown from a satellite orbit, to determine a location of a geostationary orbit using a global earth navigation satellite system according to an embodiment of the present invention; and

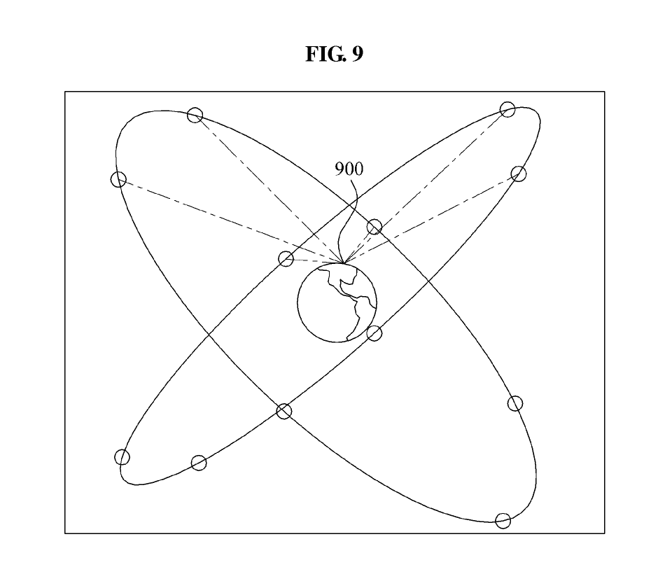

FIG. 9 illustrates an example that determines a location of a satellite in a 3D space using a global earth navigation satellite system according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Exemplary embodiments may provide a global earth navigation method, which may receive geometric shape change information associated with a target satellite through at least one inclined geosynchronous satellite, and may determine a location of the target satellite based on the received geometric shape change information.

Exemplary embodiments may provide at least one inclined geosynchronous satellite, disposed in at least one orbital plane distinguished based on an interval determined based on a longitudinal coordinate of the earth so as to compose a group of satellites, disposed at predetermined intervals in the at least one orbital plane, and revolving around the earth so as to provide, over time, geometric shape change information associated with the earth and geometric shape change information associated with a target satellite.

Exemplary embodiments may provide a global earth navigation method that determines a location of a target satellite by receiving a navigation signal from the target satellite, for example, a low earth orbit satellite, a stationary satellite, and the like.

Exemplary embodiments may provide a global earth navigation satellite system that includes a group of satellites including at least one inclined geosynchronous satellite disposed in at least one orbital plane distinguished based on an interval predetermined based on a longitudinal coordinate of the earth.

FIG. 1 illustrates a group of satellites in a global earth navigation satellite system, two-dimensionally, according to an embodiment of the present invention.

Referring to FIG. 1, at least one inclined geosynchronous satellite 101 to 112 in the global earth navigation satellite system may revolve around the earth at the same altitude as a geostationary satellite.

For example, the at least one inclined geosynchronous satellites 101 to 112 may revolve around the earth at an altitude of 35,786 kilometers (km) identical to the geostationary satellite and thus, may be applicable to vehicles, vessels, airplanes on the earth, to low earth orbit satellites, and to the geostationary satellites which are not applicable to the global positioning system (GPS).

At least one orbital plane of the global earth navigation satellite system may be disposed at intervals of 60 degrees based on a longitudinal coordinate of the earth, and may be distinguished as six orbital planes

The group of satellites in the global earth navigation satellite system may be composed of twelve inclined geosynchronous satellite, the six orbital planes including two inclined geosynchronous satellites each.

The at least one inclined geosynchronous satellite 101 to 112 may revolve around the earth at an inclination of satellite orbit of 45 degrees, and may provide, over time, geometric shape change information associated with the earth, geometric shape change information associated with a low earth orbit satellite, and geometric shape change information associated with the geostationary satellite.

Two inclined geosynchronous satellites disposed in the same orbital plane, for example, inclined geosynchronous satellites 101 and 102, inclined geosynchronous satellites 103 and 104, inclined geosynchronous satellites 105 and 106, inclined geosynchronous satellites 107 and 108, inclined geosynchronous satellites 109 and 110, and inclined geosynchronous satellites 111 and 112, may be spaced 180 degrees apart from each other.

Two inclined geosynchronous satellites disposed in the different orbital planes, for example, inclined geosynchronous satellites 101 and 103, and inclined geosynchronous satellites 102 and 104, may be spaced 60 degrees apart from each other.

FIG. 2 illustrates a group of satellites in a global earth navigation satellite system, three-dimensionally, according to an embodiment of the present invention.

Referring to FIG. 2, the inclined geosynchronous satellites 101 to 112 may revolve around the earth, once a day, at an altitude of 35,786 km identical to a geostationary satellite, and an inclination of satellite orbit may be 45 degrees.

Here, a coordinate system of the inclined geosynchronous satellites may be an earth-based inertial reference frame, and may be shown as though twelve satellites are disposed in two planes, the inclined geosynchronous satellites 101, 103, 105, 107, 109, and 111 are disposed in the same plane, and the inclined geosynchronous satellites 102, 104, 106, 108, 110, and 112 are disposed in the same plane.

FIG. 3 illustrates a ground track of each satellite based on determination of a location of a geostationary satellite in a global earth navigation satellite system according to an embodiment of the present invention.

For example, a stationary satellite situated at 10 degrees east longitude may receive navigation signals from at least ten inclined geosynchronous satellites, and may determine a location and a speed of the geostationary satellite based on the received navigation signal.

FIG. 4 illustrates a number of inclined geosynchronous satellites shown from a geostationary orbit to determine a location of a geostationary satellite using a global earth navigation satellite system according to an embodiment of the present invention.

When the geostationary satellite situated at the location of FIG. 3 receives the navigation signals, the geostationary satellite may always receive navigation signals from at least ten satellites and may not receive, from two satellites disposed on an opposite side of the earth, data at a predetermined time.

FIG. 5 illustrates a configuration of an inclined geosynchronous satellite 500 in a global earth navigation satellite system according to an embodiment of the present invention.

The inclined geosynchronous satellite 500 may include a navigation electronic unit 510 to generate a navigation signal, and a satellite bus unit 520 to generate telemetry data and a telecommand signal to control the inclined geosynchronous satellite 500.

The inclined geosynchronous satellite 500 may be disposed in at least one orbital plane distinguished based on an interval determined based on a longitudinal coordinate of the earth. The inclined geosynchronous satellite 500 may be disposed in the at least one orbital planes at predetermined intervals, and may revolve around the earth based on a predetermined inclination of satellite orbit so as to provide, over time, geometric shape change information associated with the earth, geometric shape change information associated with a low earth orbit satellite, and geometric shape change information associated with a geostationary satellite.

The inclined geosynchronous satellite 500 may revolve the earth at the same altitude as the geostationary satellite.

The navigation electronic unit 510 of the inclined geosynchronous satellite 500 may include an atomic clock unit 511 to generate a reference time, a navigation computer 512 unit to generate the navigation signal, and a navigation signal transceiver 513 to transmit and receive the navigation signal by converting the navigation signal to a signal recognizable by a different satellite or a satellite signal collecting apparatus established on the earth.

Through a telecommand data processor 521, the satellite bus unit 520 may generate telemetry data by measuring a state of the inclined geosynchronous satellite 500, and may receive a telecommand signal to convert the received telecommand signal to command data.

Through a command signal transceiver 522, the satellite bus unit 520 may receive and transmit the telecommand signal.

Through a power generator 523, the satellite bus unit 520 may provide power to the inclined geosynchronous satellite 500.

The satellite bus unit 520 may determine and control a posture of the inclined geosynchronous satellite 500 using a posture controller 524, and may move, using a satellite propulsion unit 525, the inclined geosynchronous satellite 500 based on the control of the posture controller 524.

FIG. 6 illustrates an example that determines a location of a geostationary satellite 600 in a three-dimensional (3D) space using a global earth navigation satellite system according to an embodiment of the present invention

Referring to FIG. 6, the stationary satellite 600 situated at 10 degrees east longitude may receive navigation signals from at least ten inclined geosynchronous satellites, and may determine the location and a speed of the stationary satellite 600 based on the received navigation signals.

FIG. 7 illustrates a ground track of an inclined geosynchronous satellite deployed to determine a location of a satellite located at a surface of the earth, using a global earth navigation satellite system according to an embodiment of the present invention

Referring to FIG. 7, a satellite 700 situated at 80 degrees north latitude and 30 degrees east longitude may receive navigation signals from at least six inclined geosynchronous satellites 101, 103, 106, 107, 110, and 111, and may determine a location on a surface of the earth based on the received navigation signals.

FIG. 8 illustrates a number of inclined geosynchronous satellites shown from a satellite orbit, to determine a location of a geostationary orbit using a global earth navigation satellite system according to an embodiment of the present invention

When the satellite 700 situated at a location of FIG. 7 receives the navigation signals, the satellite 700 may receive the navigation signals from the inclined geosynchronous satellites 101, 103, 106, 107, 110, and 111 excluding satellites moving southward, over time, as shown in FIG. 8.

FIG. 9 illustrates an example that determines a location of a satellite in a 3D space using a global earth navigation satellite system according to an embodiment of the present invention.

Referring to FIG. 9, a satellite 900 situated at 80 degrees north latitude and 30 degrees east longitude may receive navigation signals from at least six inclined geosynchronous satellites, and may determine a location and a speed of the satellite 900 based on the received navigation signals.

According to exemplary embodiments, there may be provided a global earth navigation satellite system capable of determining an orbit of a stationary satellite using a small number of satellites.

According to exemplary embodiments, an amount of human resources and material resources to be used for a global navigation satellite system will be reduced.

According to exemplary embodiments, a quality of image data may be improved by processing satellite navigation data and determining an orbit of a stationary satellite, accurately, without distance measuring devices for controlling and managing the stationary satellite.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files including higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A global earth navigation satellite system, the system comprising:
a group of satellites comprising at least one inclined geosynchronous satellite disposed in at least one orbital plane distinguished based on an interval determined based on a longitudinal coordinate of the earth,
wherein the at least one inclined geosynchronous satellite is disposed in the at least one orbital plane at predetermined intervals, and revolves around the earth at a predetermined inclination of satellite orbit so as to provide, over time, geometric shape change information associated with the earth, geometric shape change information associated with a low earth orbit satellite, and geometric shape change information associated with a geostationary satellite.

2. The system of claim 1, wherein a target satellite of which a location is to be determined is one of the low earth orbit satellite and the geostationary satellite.

3. The system of claim 1, wherein the at least one inclined geosynchronous satellite revolves around the earth at the same altitude as the geostationary satellite.

4. The system of claim 1, wherein the at least one orbital plane is situated at intervals of 60 degrees based on the longitudinal coordinate of the earth, and is distinguished as six orbital planes.

5. The system of claim 4, wherein the group of the satellites comprises 12 inclined geosynchronous satellites, two inclined geosynchronous satellites being disposed in each of the six orbital planes.

6. The system of claim 1, wherein the at least one inclined geosynchronous satellite revolves around the earth at an inclination of satellite orbit of 45 degrees so as to provide, over time, geometric shape change information associated with the earth, geometric shape change information associated with the low earth orbit satellite, and geometric shape change information associated with the geostationary satellite.

7. The system of claim 5, wherein the at least one inclined geosynchronous satellite comprises:
two inclined geosynchronous satellites included in the same orbital plane, spaced 180 degrees apart from each other; and
two inclined geosynchronous satellites included in different orbital planes of the orbit, spaced 60 degrees apart from each other.

8. An inclined geosynchronous satellite, comprising:
a navigation electronic unit to generate a navigation signal; and
a satellite bus unit to generate telemetry data and a telecommand signal to control the inclined geosynchronous satellite,
wherein at least one inclined geosynchronous satellite is disposed in at least one orbital plane distinguished based on an interval determined based on a longitudinal coordinate of the earth, and
the at least one inclined geosynchronous satellite is disposed in the at least one orbital plane at predetermined intervals, and revolves around the earth at a predetermined inclination of satellite orbit so as to provide, over time, geometric shape change information associated the earth, geometric shape change information associated a low earth orbit satellite, and geometric shape change information associated a geostationary satellite.

9. The inclined geosynchronous satellite of claim 8, wherein the inclined geosynchronous satellite revolves around the earth at the same altitude as the geostationary satellite.

10. The inclined geosynchronous satellite of claim 8, wherein the navigation electronic unit comprises:
an atomic clock unit to generate a reference time;
a navigation computer unit to generate the navigation signal; and
a navigation signal transceiver to transmit and receive the navigation signal by converting the navigation signal to a signal recognizable by a different satellite or a satellite signal collecting apparatus established on the earth.

11. The inclined geosynchronous satellite of claim 8, wherein the satellite bus unit comprises:
a telecommand data processor to generate telemetry data by measuring a state of the inclined geosynchronous satellite, and to receive the telecommand signal to convert the received telecommand signal to command data.

12. The inclined geosynchronous satellite of claim 11, wherein the satellite bus unit comprises:
a command signal transceiver to receive the telecommand signal and to transmit the telecommand signal.

13. The inclined geosynchronous satellite of claim 8, wherein the satellite bus unit comprises:
a power generator to supply power to the inclined geosynchronous satellite.

14. The inclined geosynchronous satellite of claim 8, wherein the satellite bus unit comprises:
a posture controller to determine and control a posture of the inclined geosynchronous satellite.

15. The inclined geosynchronous satellite of claim 14, wherein the satellite bus unit comprises:
a satellite propulsion unit to move the inclined geosynchronous satellite based on control of the posture controller.

16. A global earth navigation method, the method comprising:
receiving geometric shape change information associated with a target satellite over time through at least one inclined geosynchronous satellite; and
determining a location of the target satellite based on the received geometric shape change information,
wherein a group of satellites includes the at least one inclined geosynchronous satellite disposed in at least one orbital plane distinguished based on an interval determined based on a longitudinal coordinate of the earth, and the at least one inclined geosynchronous satellite is disposed in the at least one orbital plane at predetermined intervals, and revolves around the earth so as to provide, over time, geometric shape change information associated with the earth and geometric shape change information associated with the target satellite.
